(19) United States
(12) Patent Application Publication
(10) Pub. No.: US 2024/0429720 A1
(43) Pub. Date: Dec. 26, 2024

(54) Recharging apparatus for recharging an electric battery

(71) Applicant: EMAK S.P.A., BAGNOLO IN PIANO (RE) (IT)

(72) Inventor: Gianluca BARBOLINI, MODENA (IT)

(21) Appl. No.: 18/698,125

(22) PCT Filed: Sep. 9, 2022
(86) PCT No.: PCT/IB2022/058507

§ 371 Date: Apr. 3, 2024

(30) Foreign Application Priority Data
Oct. 7, 2021 (IT) 102021000025640

(51) Int. Cl. H02J 7/00

(52) U.S. Cl. CPC H02J 7/00034; H02J 7/0048; H02J 7/007194

(57) ABSTRACT

A recharging apparatus (30) for electrically recharging an electric battery (10) is described comprising: a battery charger device (35), a control and command electronic unit (60) galvanically connected to the battery charger device, and a wireless transmitter (65) operatively connected to the control and command electronic unit. Wherein the electronic control and command unit (60) is configured to monitor a value indicative of an operating parameter of the battery when said battery is connected to the battery charger device and to send said value via the wireless transmitter (65).

### TECHNICAL FIELD

The present invention relates to an apparatus for recharging an electric battery, in particular for recharging the battery of electric tools, e.g. for the maintenance of green spaces, provided with an electric motor powered by said battery, such as chain saws, brush cutters, hedge trimmers, blowers, lawn mowers, etc., for example.

### PRIOR ART

Tools, e.g. for the maintenance of green spaces, provided with an electric motor powered by an electric battery, such as chainsaws, brush cutters, hedge trimmers, blowers, lawnmowers, etc., are known.

These batteries, in their inside, can be provided with a monitoring device, comprising an electronic control and command unit and a wireless transmitter, configured to detect one or more operating parameters of the battery to send them to a remote device which processes them and can generate alarms that are intelligible to the tool user based on the monitored values.

For example, it is possible to monitor the residual charge of the battery and send this datum to a remote device by means of a transmitter device present in the monitoring device. This architecture can for example be used to indicate the completion of battery recharging or the current battery charge level.

One problem with this solution is that this monitoring method makes batteries more complex, thus more difficult to design, more expensive and more prone to malfunctioning, since generally an increase in the number of components in an apparatus translates into a greater number of components that can break or generate malfunctions.

An object of the present invention is to overcome the constraints of the prior art in the context of an efficient, rational and cost-effective solution.

This object is achieved by the features of the invention indicated in the independent claim. The dependent claims outline preferred and/or particularly advantageous aspects of the invention.

### DISCLOSURE OF THE INVENTION

In particular, the invention makes available a recharging apparatus for electrically recharging an electric battery (for a battery tool) comprising:
a battery charger device fitted with a power plug adapted to be electrically connected to a power source,
an electronic control and command unit galvanically connected to the battery charger device, and
a wireless transmitter operationally connected to the electronic control and command unit,
   wherein the electronic control and command unit is configured to monitor a value indicative of an operating parameter of the battery when it is connected to the battery charger device and to send said value via the wireless transmitter (to a remote device).

Thanks to this solution, the battery is simpler, with fewer components than those of the prior art, therefore less subject to breakages and malfunctions, and at the same time it is possible to monitor it and send the monitored data to a remote device while the battery is being recharged. The aspect of less battery failure is also important from a sustainability point of view, as the disposal of a non-functioning battery is much less costly, both economically and in terms of environmental impact, than the disposal of a non-functioning battery charger device. In addition, the proposed solution allows to reduce the production cost of the battery, which is particularly important considering that both private users and fleets of tools for the maintenance of green spaces generally have multiple batteries and a much smaller number of battery charger devices, for example even just one in the case of private users. Additionally, given the larger number of batteries compared to the battery charger devices, the greater simplicity of the battery allows reducing production times and related costs thereof, while still allowing the monitoring. Finally, the fact that the electronic control unit and the wireless transmitter are part of the recharging apparatus and not of the battery means that the energy of the battery is not consumed for monitoring, thus extending the durability and useful life thereof.

For example, the operating parameter of the battery is at least one between a parameter indicative of the battery temperature and a parameter indicative of the charge percentage.

In this way, the main operating parameters of the battery are monitored, which allow providing information on the available operating time of the battery, e.g. starting from the charge percentage, and on the health of the battery, starting both from the recharge percentage, e.g. reached over a certain time, and starting from the temperature, as excessive temperatures can be indicative of structural problems with the battery or of improper use or even too hot recharging locations.

According to one aspect of the invention, the recharging apparatus may comprise a remote device. In this case, the electronic control and command unit is configured to send the value indicative of the operating parameter to the remote device, which remote device is configured to monitor the received operating parameter value and to display the received operating parameter value and/or to generate an alert signal (intelligible to a user) based on the received operating parameter value.

This makes it possible to actively inform the user about the monitored data and/or to generate alarms if abnormal situations are detected, or reminders, thus making it possible to extend the useful life of the batteries and/or not to delay operations with tools provided with these batteries.

According to another aspect of the invention, the operating parameter monitored by the electronic control and command unit may be the parameter indicative of the charge percentage. In this case, the remote device may be configured to calculate a battery discharge time interval at a predetermined residual percentage based on a last received value of the parameter indicative of the charge percentage and to selectively generate an alarm signal based on at least said discharge time interval.

This reminds the user to recharge the battery, both to avoid having a flat battery when the tool is needed to be used, which would delay works, and to prevent the battery from being over-discharged, with the risk of damage and premature loss of the storage capacity for which it was designed, i.e. its useful life will be reduced.

According to yet another aspect of the invention, the operating parameter monitored by the electronic control and command unit may be the parameter indicative of the charge percentage. In this case the remote device is configured:
to calculate a battery discharge time interval at a predetermined residual percentage based on a last received value of the parameter indicative of the charge percentage
to (cyclically) connect to an additional remote weather forecasting device,
to monitor the status of the weather forecast for a next day, said status being between cloudy, rainy and sunny,
to generate an alert signal when the forecast status for that next day is cloudy or sunny and when the residual charge expected for that day is less than a predetermined percentage.

This allows the user to be warned, on days when he could potentially use the tool, that he must recharge the battery beforehand if he wants to use the tool on those days, otherwise works will be delayed or impossible due to the need to charge the battery.

According to yet another aspect of the invention, the operating parameter monitored by the electronic control and command unit may be the parameter indicative of the battery temperature, and the remote device may be configured to generate an alert signal when the value of the parameter indicative of the battery temperature exceeds a predetermined threshold value.

Thanks to this solution, the user can be informed about possible dangerous conditions of the battery.

Again when the operating parameter is the parameter indicative of the battery is the parameter indicative of the temperature, according to a different aspect of the invention, the electronic control and command unit may be configured to cyclically detect the value of the parameter indicative of the temperature of the battery as soon as the battery is connected to the battery charger device, and the remote device may be configured to generate a preset alert signal when the temperature, in a predetermined time interval starting from the moment in which the battery is connected, exceeds a predetermined threshold value.

When the battery is excessively hot in the moment in which it is connected to the battery charger for recharging, it means that it has been kept in an excessively hot place, or, when it is recharged immediately after being used, it means that the battery is undersized for the tool and for the usage to which it has been connected. Sending an alert signal to signal this condition allows avoiding both an early reduction in battery useful life and possible damages to the tool to which the battery is connected, caused by temperatures higher than those for which it was designed.

Again when the operating parameter is the parameter indicative of the battery is the parameter indicative of the temperature, the electronic control and command unit may be configured to cyclically detect the value of the parameter indicative of the battery temperature while recharging and to cyclically send the detected value to the remote device, and the remote device may be configured to calculate the average or median temperature while recharging the battery and to generate a (further) preset alert signal when the calculated average or median temperature exceeds a predetermined threshold value.

When the temperature of the battery while recharging, for example throughout the recharging cycle intended as a low battery to full battery process, is too high, this may mean that either the place where recharging is taking place is too hot, or that the battery is unbalanced, that is, it has an internal electrical resistance that is too high, therefore it is defective, and it is convenient to replace it. Also in this case, sending an alert signal to signal this condition avoids both an early reduction in the battery useful life and any damages to the tool to which the battery is connected, caused by temperatures higher than those for which it was designed and due to the too high electrical resistance of the battery.

According to another aspect of the invention, the remote device may be configured to store the values of the operating parameter during each connection of the battery to the battery charger device, to calculate a median or average value of the operating parameter based on the values acquired during a first set of connections of the battery to the battery charger device, and to generate an alert signal when the average or median value of the operating parameter in a successive connection of the battery deviates from the calculated average or median value by more than a predetermined percentage value.

This allows the user to be warned of any changes in the performance of the battery during recharging, which may be indicative of a premature deterioration. Consequently, the apparatus thus allows the user to be made aware of possible problems so that he can remedy them promptly and so as to avoid delays in works or damages to tools.

Another way to achieve these advantages is to carry out a usage profiling.

For example, an aspect of the invention may provide that the remote device may be configured (to store the moment in which the battery has reached a predetermined charge percentage) to calculate the time elapsed between two successive moments in which the battery has reached a predetermined charge percentage, to repeat this calculation for a predetermined subsequent number of recharges of the battery, to calculate an average value of the time intervals lapsed between two successive moments in which the battery has reached a predetermined charge percentage of the predetermined subsequent number of recharges, and to generate an alert signal based on this average time interval between two successive moments in which the battery has reached a predetermined charge percentage.

The invention further makes available a kit comprising an electric tool, provided with an electric battery adapted to power it, and a recharging apparatus according to claim 1 for electrically recharging said battery.

### BRIEF DESCRIPTION OF THE DRAWINGS

Further features and advantages of the invention will be more apparent after reading the following description provided by way of a non-limiting example, with the aid of the accompanying drawings.

FIG. 1 is a schematic view of a kit according to the invention comprising a battery powered electric tool and a battery recharging apparatus.

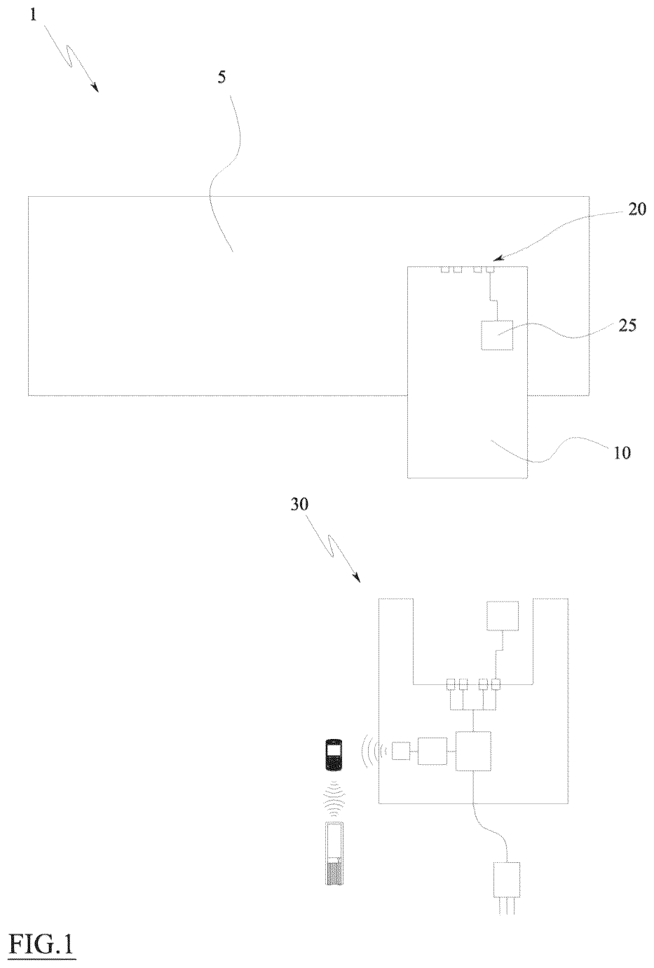

FIG. 2 is a schematic view of the apparatus according to the invention.

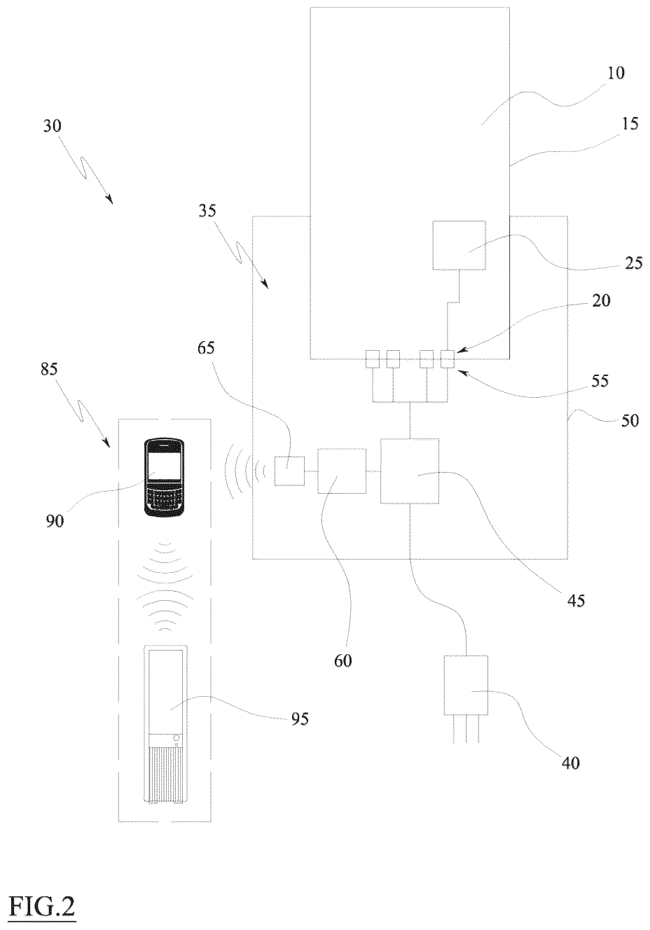

FIG. 3 is a schematic view of another embodiment of the apparatus according to the invention.

### BEST MODE TO IMPLEMENT THE INVENTION

With particular reference to said figures, a kit comprising a tool 5, preferably specific for the maintenance of green spaces, provided with an electric motor for operating the tool and an electric battery 10 of a removable type, i.e. it can be fixed in a removable way to the body of the tool, for powering said electric motor, has been globally indicated by 1.

The tool can, for example, be any one of a chainsaw, a brush cutter, a hedge trimmer, a blower, a lawnmower, a trimmer, a walking tractor, a drill, a milling machine, a hacksaw or a screwdriver.

The battery 10, for example of the chemical energy storage type, is provided with a protective box-shaped casing 15, preferably provided with quick coupling/release means for fixing it in a removable way to the tool.

The protective box-shaped casing 15 is made of an electrically non-conductive material, for example a polymeric material.

The battery is also provided with at least one electrical connector 20 that protrudes externally to the casing to allow the electrical connection to the tool in order to power supply it.

It should be noted that an electrical connector is defined as a connector which enables a galvanic (not wireless) electrical connection to be established between two electrical or electronic devices, each fitted with a connector that can be coupled to the connector of the other device.

There may also be several connectors or the connector may be made in several portions. For example, typically the electric batteries for electric tools comprise a plurality of slats placed side by side and made of an electrically conductive material. Alternatively, the connector might be of the cylindrical type. The connectors must have at least two portions, one of which forms a positive pole and the other forms a negative pole.

Furthermore, the battery may comprise a sensor 25 configured to measure a value of a parameter indicative of the temperature of the battery, for example to measure a value of the temperature of the battery. Preferably, this sensor is housed inside the casing and can be connected to the external environment to transmit the measured values either by means of the electrical connector 20 or by means of its special electrical connector independent of the electrical connector 20.

The kit 1 further comprises a recharging apparatus 30 for electrically recharging the battery 10, adapted to be connected to an electric power source, such as for example an electric power distribution network, to recharge the battery.

In particular, the recharging apparatus 30 is preferably made as a separate body from the tool body.

The recharging apparatus comprises a battery charger device 35 adapted to be connected to the electric power source, for example by means of a power supply plug 40, to recharge the battery.

In particular, it comprises an electronic monitoring and command unit 45 configured to carry out the battery recharging process (in the sense of transferring energy from the electric power source to the battery).

This electronic monitoring and command unit 45 may be configured to modulate the intensity of the electrical current supplied to the battery during recharging according to the charge percentage of the battery, for example by decreasing the intensity of the current sent to the battery as the charge percentage of the battery increases. In particular, the charge percentage can be determined by detecting the voltage level of the battery. In detail, in order to show the recharge percentage on a display, for example, the voltage value must be converted into a battery percentage based on a preset table (determined experimentally) and possibly stored in the unit.

In the case where the electric power source is the power distribution network, which is of the alternating type, the electronic monitoring and command unit 45 is configured to convert the alternating current of the power distribution network into a direct current suitable for powering the battery.

The battery charger device can comprise a box-shaped casing 50, made as a separate body with respect to the body of the tool, for example inside which the electronic monitoring and command unit is contained (in a non-removable way).

This box-shaped casing 50 may comprise a seat adapted to house at least partially, and possibly to allow the removable fixing to it, for example by means of the coupling/release means, of the battery 10.

The user can then release the battery from the tool and associate it with the box-shaped casing, for example by inserting it in this seat.

The box-shaped casing 50 is made of an electrically non-conductive material, for example a polymeric material.

The recharging apparatus comprises at least one electrical connector 55 configured to be coupled to the electrical connector 20 so as to transfer it at least the electric energy. In particular, it is electrically (galvanically) connected to the monitoring and control unit (which essentially acts as a bridge between the power supply plug and said electrical connector 55).

The electric connector 55 protrudes externally with respect to the box-shaped casing and, if the seat is present, it is located inside it.

The detection of the voltage of the battery by means of the monitoring and control unit can take place for example by measuring it at the electrical connector 55, for example by means of the portions which form a negative pole and those which form a positive pole.

The recharging apparatus comprises an electronic control and command unit 60 galvanically connected to the battery charger device, in particular to the electronic monitoring and command unit 45.

In the embodiments illustrated, these two units are two separate electronic components connected to each other, each provided with its own CPU. However, it is not ruled out that in a different embodiment these two units may be substantially a single unit, for example provided with a single CPU that performs all the functions.

The electronic control and command unit 60 is powered by the electric energy coming from the connection plug and not by the battery electricity, therefore it only works, as well as the electronic monitoring and command unit 45, when the battery charger device is connected to the electric power source.

The recharging apparatus also comprises a wireless transmitter 65 operatively connected to the electronic control and command unit 60. Preferably it is only a transmitter and not also a receiver. However, it cannot be ruled out that it may be a transceiver in the event that the activation of the electronic control and command unit 60 is required via a remote command.

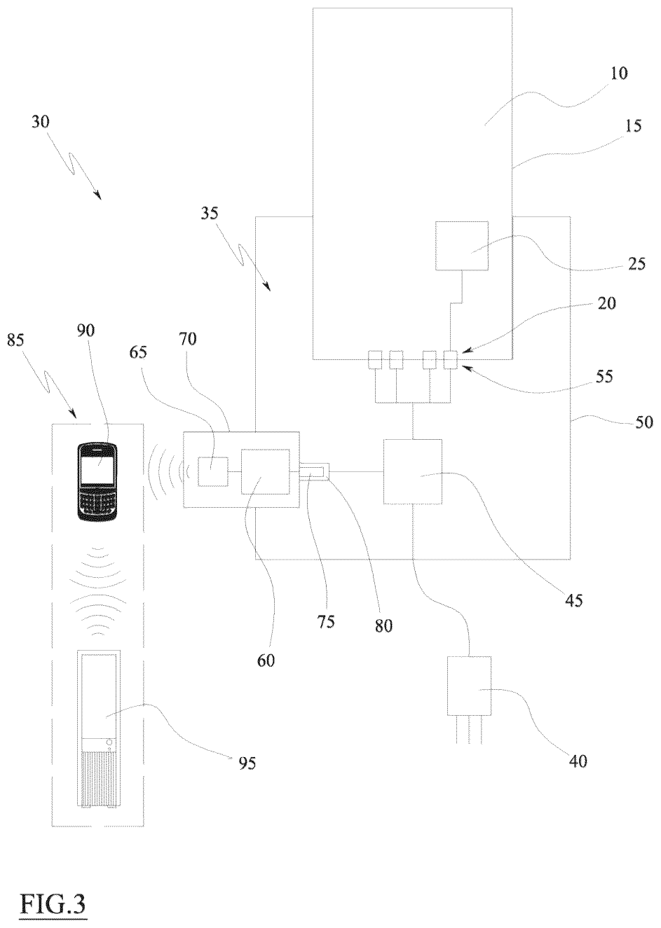

The electronic control and command unit and the wireless transmitter 65 may be located within the battery charger device 35, for example closed inside its box-shaped casing 50, or alternatively, as illustrated in FIG. 3, they can be configured as an additional mode provided with its box-shaped body 70 and with an electrical connector 75 to be connected to the battery charger by means of a special electrical connector 80 (different from the one used for recharging the battery) galvanically connected to the electronic monitoring and command unit 45. In the illustrated embodiment, the box-shaped casing 50 also comprises a seat for the stable housing of this additional module. This makes it possible to standardise production, producing a single battery charger device provided with the appropriate electrical connector for delivering said additional module, which a user can add should he need the functions it provides.

The electronic control and command unit 60 is configured to monitor (in real time) a value of at least one operating parameter of the battery 10 (i.e., a value of a parameter that is indicative of an operating parameter of the battery) when it is connected to the battery charger device, for example such monitoring takes place via the electrical connectors of the battery charger device. In particular, a value of a parameter that can be measured at this electrical connector or communicated by the battery through this electrical connector is monitored (for example in the case of the temperature sensor). If necessary, this communication between the electronic control and command unit 60 and the electric connector may take place or may not take place at all by interposition of the electronic monitoring and command unit. For example, the electronic control and monitoring unit can be used to provide the electronic control and command unit with the value of the battery charge percentage, and possibly also the battery temperature value detected by the temperature sensor present in the battery.

In particular, in the illustrated embodiment, the electronic control and command unit is directly connected to the electronic monitoring and command unit, which can, for example, provide it with the value of the monitored operating parameter (between the temperature value and the recharge percentage).

The monitoring carried out by the electronic control and command unit 60 is cyclical with a preset sampling time.

The operating parameter of the battery monitored by the electronic control and command unit is at least one between a parameter indicative of the battery temperature and a parameter indicative of the charge percentage.

The electronic control and command unit 60 is configured to send this monitored value via the wireless transmitter 65 to a remote device 85, for example forming part of the kit. The remote device is an electronic device provided with a control unit or CPU and at least one wireless receiver, preferably a wireless transceiver. Such a remote device could be portable, such as a smartphone 90 or a tablet or a portable computer or an ad hoc-built portable wireless electronic device, or it could be non-portable, such as a remote desktop computer 95, preferably a remote server.

For example, the remote device may comprise a portable device, such as a smartphone 90 or a tablet or an ad hoc-built portable wireless electronic device, capable of communicating wirelessly with the transmitter of the recharging apparatus and configured to send the value of the monitored operating parameter to the remote computer, that is to the remote server, for example via a wireless connection, preferably an internet connection.

In the preferred embodiment, the remote device comprises both the portable device, e.g. in the form of the smartphone 90, and the remote desktop PC 95.

The wireless electronic device built ad hoc for the kit could therefore be a simple device provided with a transceiver and a control unit capable of receiving a signal from the transmitter device connected to the electronic control and command unit 60 to then forward it to the remote computer, or, alternatively or additionally, it could be provided with an interface device, such as a display or one or more light or acoustic emitters, and a control unit configured to process the data received from the transmitter and make them intelligible (possibly after processing them) to a user via the interface device.

Irrespective of the exact configuration of the remote device, the electronic control and command unit 60 can be configured to send the value indicative of the operating parameter to the remote device cyclically (at a preset time interval) in real time during battery recharging.

“During battery recharging” means an interval of time in which the electrical connector of the battery is coupled to the electrical connector of the recharging device and simultaneously the recharging device is connected to the electric power source and sends electric energy to the battery.

It is not excluded that the recharging apparatus may comprise a memory unit operationally connected to the electronic control and command unit 60, for example inserted in the additional module, in which the monitored values of the operating parameter during recharging are stored, so that they may be available also after the battery recharging step in case the remote device is not connected during the recharging step. In this case it is also preferable that the memory is of the non-volatile type or that alternatively it is volatile, but that an auxiliary battery is also provided (in the recharging device or in the additional module) so that the acquired data are not lost.

Irrespective of the configuration of the remote device, it is configured to monitor the value of the received operating parameter (i.e. the value of the parameter that is indicative of the received operating parameter) and to display the value of the received operating parameter (e.g. on a display of the remote device) and/or to generate an alert signal (intelligible to a user) based on the value of the received operating parameter.

The step of displaying the value of the operating parameter and/or generating an alert signal on it is preferably preceded by the step of calculating said operating parameter value based on the parameter value that is indicative of the received operating parameter.

The visualisation can take place via a display or light emitters (LEDs) coupled with a legend or scale printed on the body of the remote device.

The alert signal may be in various forms, e.g. it may be (at least one between) a predetermined switch-on pattern of the light emitter(s), it may be a predetermined switch-on pattern of the acoustic emitter(s), it may be in the form of a character string (preset or determined based on the value of the operating parameter), indicating the detected problem and/or in which it is suggested how to avoid a possible problem, which is shown on a display of the remote device, it may be in the form of a text message containing the aforesaid character string (e.g., sent from the remote computer to the smartphone or to the tablet or to the ad hoc portable device, or again generated and displayed by the same three portable devices indicated), it may be in the form of said (preset or determined based on the value of the operating parameter) character string that the remote device is configured to save as a reminder in a software of a digital calendar with which in such case the remote device must be provided (the remote device, or its control unit, is configured to run the software, or the computer code, of the digital calendar, for example said software being saved in a memory unit of the remote device), for example said remote device being one between a smartphone and a tablet.

Additionally, the alert signal can be generated in real time or alternatively the remote device can be configured to calculate a time interval based on the value of the operating parameter or to use a preset time interval, after which it generates the alert signal.

The battery 10 can be provided with an identification code of the single battery, that is different for each battery. In this case, the electronic control and command unit is also configured to detect this identification code and to send it to the remote device, which is configured to associate the detected identification code with the received operating parameter value(s) and to generate alert signals correlated to the identification code. This makes it possible to manage a plurality of batteries which are recharged with the same recharging device.

Some examples of configuring the generation of alert signals according to the operating parameters described above are described below. These configurations may be alternative or cumulative with each other.

Monitoring the parameter indicative of the charge percentage and the generation of an alert signal based on it, allow the user to be reminded to recharge the battery, both to avoid finding himself with a flat battery when he needs to use the tool, which would delay works, and to prevent the battery from being over-discharged, with the risk of damage and of premature loss of the storage capacity for which it was designed, i.e. its useful life would be reduced.

In particular, the remote device may be configured to calculate a battery discharge time interval at a preset residual percentage (which is thus a predetermined threshold value), based on a last received value of the parameter indicative of the charge percentage, and to selectively generate an alarm signal based on at least said discharge time interval. For example, after receiving the last value of the parameter indicative of the charge percentage, the remote device is configured to calculate said discharge time interval in the manner indicated above and to start said interval from the moment of receiving the last value of the parameter indicative of the charge percentage. The remote device can also be configured to calculate date and time of the moment in which the discharge time interval ends starting from the moment in which the last value was received.

The generation of the alert signal could be in real time, e.g. by means of a character string indicative of the value of the discharge time interval or indicative of the time and date of the end of the discharge time interval, which string can be shown on a display of the remote device. Alternatively or additionally, the alert signal may comprise the generation of a reminder in the digital calendar at the time and date of the end of that time interval.

Alternatively or additionally, the remote device could be configured to generate a timer of length equal to the discharge time interval, to activate said timer after receiving the last value of the parameter indicative of the charge percentage and to generate the alert signal at the end of this timer.

In this case the alert signal could be a character string indicating that battery recharging is required immediately, e.g. shown on the display, preferably in the form of a message, or an activation of the light emitter and/or of the acoustic emitter.

The last received value of the parameter indicative of the battery charge percentage can be determined mainly in two ways: either as the last received value before a time interval which is a multiple of the predetermined time interval by which the electronic control and command unit sends the value indicative of the battery charge percentage to the remote device and during which no signal is received from the electronic control and command unit containing the value of the parameter indicative of the battery charge percentage, or as the last received value before receiving a signal from the electronic control and command unit indicating that the battery has been removed from the battery charger device. In the latter case, the electronic control and command unit 60 must also be configured to detect the presence of a battery connected to the battery charger and being recharged. This can be done by the electronic control and command unit by monitoring the current flow from the power source to the battery; when this passage of current is interrupted, it means that the battery has been removed from the battery charger device.

Again when the operating parameter monitored by the electronic control and command unit 60 is the parameter indicative of the charge percentage, the remote device can be configured:
to calculate a battery discharge time interval at a predetermined residual percentage based on a last received value of the parameter indicative of the charge percentage (in the same way as illustrated above for the other configuration of the remote device)
to (cyclically) connect to an additional remote weather forecasting device,
to monitor the status of the weather forecast for a next day, e.g. between 1 and 10 days, to the one on which the monitoring is taking place, said status being between cloudy, rainy and sunny, and
to generate an alert signal when the forecast status for that next day is cloudy or sunny and when the residual charge expected for that day is less than a predetermined percentage.

This predetermined percentage may for example be higher than that discussed in the previous mode, e.g. it may be comprised between 80% and 50%.

The generation of the alert signal could be in real time, e.g. by means of a character string indicating that on a predetermined next day the weather will be suitable for the use of the tool (in particular in case of tools for the maintenance of green spaces) and that the battery should be charged by that day. This string can be shown on a display of the remote device. In addition or as an alternative, it can be provided that a reminder is generated in the digital calendar on the day before the predetermined day.

Alternatively, or in addition to the two modes described above, the operating parameter monitored by the electronic control and command unit 60 may be the parameter indicative of the battery temperature, and the remote device in that case may be configured to generate an alert signal when the value of the parameter indicative of the temperature exceeds a predetermined threshold value.

The alert signal could be, for example, a character string indicating that the battery temperature is excessive, shown on a display of the remote device.

Preferably, it may be appropriate to set three different threshold values to which different severities correspond, for example a first predetermined threshold value, a predetermined second threshold value lower than the first threshold value, and a third predetermined threshold value lower than the second threshold value. Each of these thresholds can be combined with an alert signal that is gradually more invasive from the third threshold towards the first threshold.

For example, the first threshold value may be a peak temperature value about which the user must be informed because the temperature may be dangerous and it is advisable to stop recharging immediately.

The electronic control and command unit 65 may be configured to cyclically detect the value of the parameter indicative of the battery temperature as soon as the battery is connected to the battery charger device (as soon as it is connected, the passage of electricity begins), preferably during the entire recharging time.

The remote device can be configured to generate a (second) preset alert signal (indicative of a too hot battery) when the temperature, in a predetermined time interval starting from the moment in which the battery is connected, e.g. between 10 and 60 seconds from the start of recharging, exceeds a predetermined threshold value, which can for example be second predetermined threshold value. The remote device can also be configured to calculate an average or median temperature in said predetermined time interval starting from the moment in which the battery is connected, to compare this calculated value with the (second) predetermined threshold value, and to generate the alert signal if the calculated value is greater than the (second) threshold value (less than the first preset threshold value).

In this case the alert signal, which is preferably sent in real time, is an indication that the battery is not suitable or that the location is too hot, e.g. an indication that the purchase of a more powerful battery is suggested.

Similarly to the previous cases, the alert signal may be a character string indicating that the battery is unsuitable and that is shown on a remote device display, or a predetermined pattern of acoustic and/or light signals generated by the respective light and acoustic signallers.

In addition to monitoring the temperature in the first recharging step, as mentioned above, it is possible to monitor it throughout the recharging moment and in this case the remote device is configured to calculate the average temperature, preferably the median temperature, obtained from all the values of the parameters indicative of the temperature that have been received from the moment in which recharging begins to the moment in which recharging is finished or in any case the moment in which the battery is removed from the battery charger device.

The remote device is then configured to compare the calculated temperature value with a preset threshold value, e.g. the third predetermined threshold value, and to generate a (third) preset alert signal when the calculated value exceeds this threshold value (and is lower than the second threshold value).

This (third) predetermined alert signal, which is preferably sent in real time, is an indication that the battery is potentially defective and dangerous.

Similarly to the previous cases, the alert signal may be a character string indicating that the battery is potentially defective and dangerous and that is shown on a remote device display, or a predetermined pattern of acoustic and/or light signals generated by the respective light and acoustic signallers. This character string is different from the previous ones in order to distinguish the three different types of problems encountered at the three different temperature thresholds.

The remote device can also be used to perform a battery profiling to monitor the ageing thereof and inform the user that the battery needs to be replaced.

For example, the remote device may be configured to store the values of the operating parameter during each connection of the battery to the battery charger device, to calculate a median or average value of the operating parameter based on the values acquired during a first set of connections, e.g., the first 5 or 10 connections, of the battery to the battery charger device, and to generate an alert signal when the average or median value of the operating parameter, in a successive connection of the battery to the battery charger device, deviates from the calculated average or median value by more than a predetermined percentage value.

The monitored operating parameter can be both the charge percentage and the temperature. In particular, in the case of the charge percentage, the value on which the average value is calculated is the recharging time, i.e. the time that lapses between the passage to a predetermined lower limit of battery charge percentage and a predetermined upper limit of battery charge.

In the case of temperature, the median temperature is preferably calculated from all temperature values received during the first set of connections of the battery to the battery charger device.

The remote device can also be configured to perform a usage profiling, understood as frequency of usage, made of the battery charger device so as to be able to provide the user with a reminder on when to recharge the battery and thus free the user from having to remember to recharge the battery.

In such a case, for example, the remote device may be configured (to store the moment in which the battery has reached a predetermined charge percentage) to calculate the time elapsed between two successive moments in which the battery has reached the predetermined charge percentage, to repeat this calculation for a predetermined subsequent number of recharges of the battery, to calculate an average value of the time intervals lapsed between two successive moments in which the battery has reached a predetermined charge percentage of the predetermined subsequent number of recharges, and to generate an alert signal based on this average time interval between two successive moments in which the battery has reached a predetermined charge percentage.

This alert signal can be in real time and in the form of a reminder saved in the digital calendar, which contains a character string indicating that the battery needs to be recharged by the calculated date. Or it may be an alert signal generated when, after the average time interval since the last recharge has lapsed, no battery connection to the battery charger device is detected.

This mode can also be recursive, for example, after a learning phase identifiable in the predetermined set of successive recharges, which are preferably a set of recharges starting from the first recharge, the remote device can be configured to calculate each successive time the time between two successive recharges and to recalculate the average time interval, in order to better adapt to the use made of the recharging device. In the previously described cases where a reminder is saved in the digital calendar, if the battery is subsequently connected to the battery charger before the reminder date and time, the electronic control and command unit is configured to detect the presence of reminders in the digital calendar and to delete them. This avoids unnecessary redundant alert signals.

The operation of the invention is as follows.

The invention thus conceived is susceptible to many modifications and variants, all falling within the same inventive concept. Moreover, all details can be replaced by other technically equivalent elements.

In practice, the materials used, as well as the contingent shapes and sizes, can be whatever according to the requirements without for this reason departing from the scope of protection of the following claims.

1-14. (canceled)

15. A recharging apparatus for electrically charging an electric battery comprising:
a battery charger device,
an electronic control and command unit galvanically connected to the battery charger device, and
a wireless transmitter operationally connected to the electronic control and command unit,
wherein the electronic control and command unit is configured to monitor a value indicative of an operating parameter of the battery when said battery is connected to the battery charger device and to send said value via the wireless transmitter,
wherein the electronic control and command unit is configured to send the value indicative of the operating parameter to the remote device, and wherein the remote device is configured to monitor the received operating parameter value and to display the received operating parameter,
wherein the electronic control and command unit is configured to send the value indicative of the operating parameter to the remote device cyclically in real time during battery recharging.

16. The recharging apparatus according to claim 15, wherein the operating parameter of the battery is at least one between a parameter indicative of the battery temperature and a parameter indicative of the battery charge percentage.

17. The recharging apparatus according to claim 15, wherein the operating parameter monitored by the electronic control and command unit is the parameter indicative of the battery charge percentage, and wherein the remote device is configured to calculate a battery discharge time interval at a predetermined residual percentage based on a last received value of the parameter indicative of the charge percentage and to selectively generate an alarm signal based on at least said discharge time interval.

18. The recharging apparatus according to claim 15, wherein the operating parameter monitored by the electronic control and command unit is the parameter indicative of the battery charge percentage, and wherein the remote device is configured:
to calculate a battery discharge time interval at a predetermined residual percentage based on a last received value of the parameter indicative of the charge percentage,
to connect to an additional remote weather forecasting device,
to monitor the status of the weather forecast for a next day, said status being between cloudy, rainy and sunny, and
to generate an alert signal when the forecast status for that next day is cloudy or sunny and when the residual charge expected for that day is less than a predetermined percentage.

19. The recharging apparatus according to claim 15, wherein the operating parameter monitored by the electronic control and command unit is the parameter indicative of the battery temperature and the remote device is configured to generate an alert signal when the value of the parameter indicative of the temperature exceeds a predetermined threshold value.

20. The recharging apparatus according to claim 19, wherein the electronic control and command unit is configured to cyclically detect the value of the parameter indicative of the battery temperature as soon as the battery is connected to the battery charger device, and wherein the remote device is configured to generate a preset alert signal when the temperature, in a predetermined time interval starting from the moment in which the battery is connected, exceeds a predetermined threshold value.

21. The recharging apparatus according to claim 19, wherein the electronic control and command unit is configured to cyclically detect the value of the parameter indicative of the battery temperature while recharging and to cyclically send the detected value to the remote device, and wherein the remote device is configured to calculate the average or median temperature while recharging the battery and to generate a preset alert signal when the calculated average or median temperature exceeds a predetermined threshold value.

22. The recharging apparatus according to claim 15, wherein the remote device is configured to store the values of the operating parameter during each connection of the battery to the battery charger device, to calculate a median or average value of the operating parameter based on the values acquired during a first set of connections of the battery to the battery charger device, and to generate an alert signal when the average or median value of the operating parameter in a successive connection of the battery deviates from the calculated average or median value by more than a predetermined percentage value.

23. The recharging apparatus according to claim 15, wherein the remote device can be configured to calculate a time interval lapsed between two successive moments in which the battery has reached a predetermined charge percentage, to repeat this calculation for a predetermined number of successive recharges of the battery, to calculate an average value of the time intervals lapsed between two successive moments in which the battery has reached a predetermined charge percentage of the predetermined number of successive recharges and to generate an alert signal based on this average time interval between two successive moments in which the battery has reached a predetermined charge percentage.

24. The recharging apparatus according to claim 15, wherein the alert signal is a string of characters indicative of the problem detected and/or in which it is suggested how to avoid a possible problem, wherein the remote device comprises a digital calendar software, and wherein the remote device is configured to save the string of characters in said digital calendar software as a reminder.

25. The recharging apparatus according to claim 15, wherein the remote device can be configured to calculate a time interval based on the value of the operating parameter or to use a preset time interval, after which it generates the alert signal.

26. A kit comprising an electric tool, provided with an electric battery adapted to power the electric tool, and the recharging apparatus according to claim 15 for electrically recharging said electric battery.
